(19) United States
(12) Patent Application Publication
(10) Pub. No.: US 2011/0280110 A1
(43) Pub. Date: Nov. 17, 2011

(54) Indicator timepiece having light diffusing effect

(76) Inventor: Ming-Hsien Chen, Taipei City (TW)

(21) Appl. No.: 12/800,337

(22) Filed: May 13, 2010

(51) Int. Cl. G04B 19/30

(52) U.S. Cl. 368/67

(57) ABSTRACT

An indicator timepiece having a light diffraction function is provided. Therein a light diffusion unit is provided between a timepiece movement and a time indicating unit of the indicator timepiece for receiving a lighting device and providing at least light diffraction to a light generated from the lighting device. Thereby the light diffraction of the light diffusion unit converts the light into a sheet-like lighting presented on the time indicating unit.

### BACKGROUND OF THE INVENTION

1. Technical Field

The present invention relates to improvement of lighting with regard to an indicator timepiece, and more particularly, to an indicator timepiece that has a lighting device providing a novel light diffusing effect so as to light the timepiece at night or dark place for telling the time and to make the timepiece itself serve as a lighting device.

2. Description of Related Art

A timepiece exists as an important necessity in common forms of a watch, a desk clock, an alarm clock and the like in our daily modern life. In the very beginning, a timepiece manufacturer used to apply fluorescent coatings on the hour hand or time indicating figures of timepiece in order to facilitate the user to tell the time in dark place. With the advance of lighting technology and raising level of life quality, the lighting of timepiece is on the trend of wide variety and artistry in appearance.

Referring to a desk clock (90) having a lighting function regularly seen in the market as shown in FIG. 1, the lighting function relies on a dot light source (92) located on one side of a dial (91). The dot light source (92) provides a direct lighting to the dial (91). However, due to the property of emission of beam line and the location thereof, said dot light source (92) can only provide a sector-like lighting zone; that is, the lighting zone is limited to such zone rather than the whole surface of the dial (91). In such case, it is not only a disadvantage for people to tell the time, but also inadequate for the lighting effect. To enhance the lighting effect, although it is workable to add additional light sources on the timepiece, an unfavorable cost increase to raw material and rise in consumption of electricity will occur along with further complication in assembling operation.

### SUMMARY OF THE INVENTION

To overcome the shortcomings of a built-in lighting device of conventional timepiece, the present invention aims at providing an indicator timepiece having a light diffusing effect, wherein a light diffusion unit is set. The light diffusion unit converts a dot light source into a sheet-like lighting on the strength of diffraction phenomenon so as to light up the time indicating unit evenly and wholly for telling the time at night or dark place and making the indicator timepiece served as lighting device.

For realizing above goals, the indicator timepiece having a light diffusing effect in the present invention consists of a circuit board connected with and supplied by a power supply, a timepiece movement electrically connected with and controlled by the circuit board to count time, a time indicating unit connected with and controlled by the timepiece movement to display time, a lighting device electrically connected with and controlled by the circuit board to light up the dial of timepiece and a light diffusion unit set between the timepiece movement and the time indicating unit so as to enclose the lighting device and provide at least diffraction to a light generated therefrom. Thereby the light generated from the lighting device is turned into a sheet-like lighting on the time indicating unit by means of the diffraction caused by the light diffusion unit, and further achieve an evenly and wholly light diffusing effect.

The implementation of the present invention can achieve at least following objectives.

The most important objective of the present invention is to provide an indicator timepiece having a light diffusing effect for giving an adequate lighting on the timepiece in order to tell the time at night or dark place.

Another objective of the present invention is to make the indicator timepiece serve as a lighting device similar to a night lamp.

Another objective of the present invention is to offer a light diffusion unit in simple structure to be equipped with an indicator timepiece having a light diffusing effect and is adaptive to existing assembling procedure without additional device or working process.

Another objective of the present invention is to provide a cost-effective and durable light diffusion unit of indicator timepiece causing a light diffusing effect in that said light diffusion unit features in low manufacturing cost and long lifespan.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of an illustrative embodiment when read in conjunction with the accompanying drawings, wherein:

FIG. 1 is a front view of a known indicator timepiece having lighting function in the prior art.

FIG. 2 is a perspective view of an indicator timepiece having light diffusing effect in the present invention.

FIG. 3 is an exploded view of the indicator timepiece having light diffusing effect in the present invention.

FIG. 4 is a sectional view of the indicator timepiece having the light diffusing effect in the present invention.

FIG. 5 is an enlarged exploded view of the light diffusion unit provided on the indicator timepiece having light diffusing effect in the present invention.

FIG. 6 is an implementing view showing the light diffusion unit provided on the indicator timepiece having the light diffusing effect in the present invention.

FIG. 7 is a front view of the indicator timepiece having light diffusing effect, which is provided by a light diffusion unit in the present invention.

FIG. 8 is an implementing view showing the combination of a time indicating unit and the light diffusion unit of the indicator timepiece having light diffusing effect in the present invention.

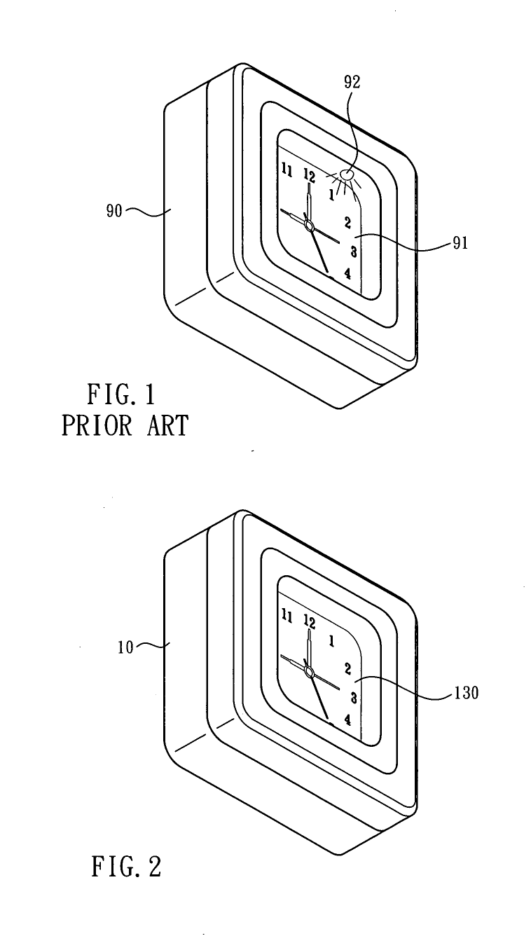

### DETAILED DESCRIPTION OF THE PREFERRED EMBODIMENT

For the convenience of explanation of the concept of subject matter in the present invention, herein disclose a preferred embodiment. It is noted that all objects contained in the embodiment are described in an appropriate ratio, scale, deformation or displacement quantities applicable to the scope of explanation purpose rather than the ratio of any actual elements of the present invention.

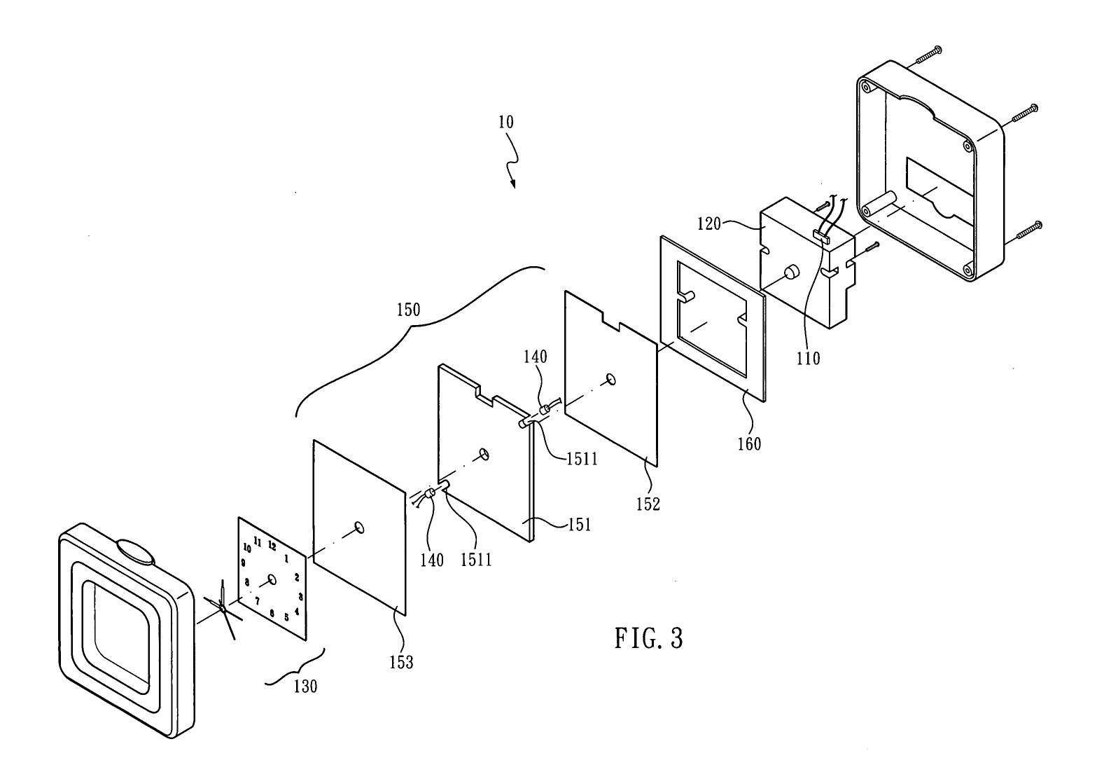

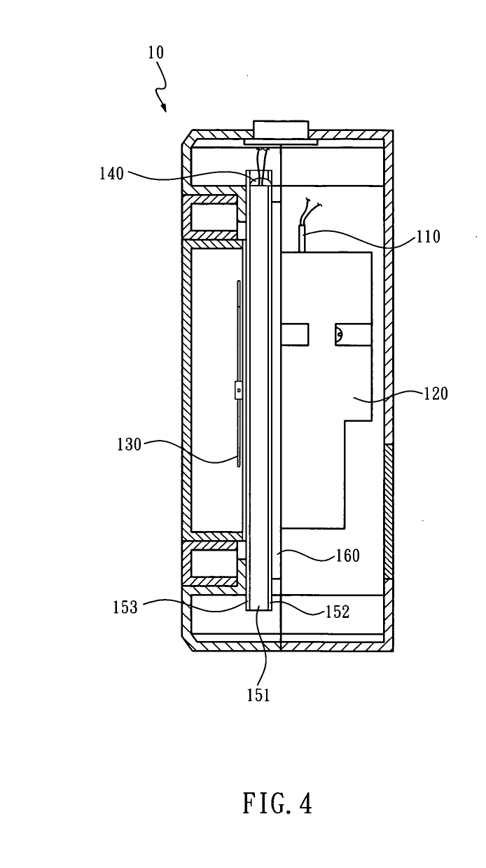

By referring to FIG. 2 through FIG. 4, include a perspective view, exploded view and a sectional view of an indicator timepiece having a light diffusing effect in the present invention. As shown in the Figures, the present invention relates to an indicator timepiece (10) having light diffusing effect composed of a circuit board (110), a timepiece movement (120), a time indicating unit (130), a lighting device (140), a light diffusion unit (150) and a fastening member (160). The layout and function of said elements in the indicator timepiece are described as set forth in the following paragraphs.

The circuit board (110) is a commonly used printed circuit board and connected with a power supply (not shown) for receiving the electricity supplied therefrom, the power supply may be a dry battery or an AC external power supply. The timepiece movement (120) of timepiece is a widely used timepiece movement in quartz watches, and it is coupled with and controlled by the circuit board (110) to count time; the timepiece movement (120) is fixed on one side of the fastening member (160) opposite to the side where the time indicating unit set. The time indicating unit (130) is connected with the timepiece movement (120) so as to be controlled by the timepiece movement (120) to display the time. In the embodiment, the time indicating unit (130) is consisting of a transparent sheet printed with time indicating figures and at least one hour hand and a minute hand, further including a second hand connected with the timepiece movement. The lighting device is connected with and controlled by the circuit board for providing a light source. In the embodiment, two LEDs (140) are implemented in order to provide lighting to the indicator timepiece.

It is necessary to point out that said elements are known to be the common components of a timepiece, which has a lighting function thereon. The feature believed characteristic of the present invention lies in that the diffraction generated by the light diffusion unit (150) converts the light produced from the lighting device LED (140) into a sheet-like lighting over the whole time indicating unit (130) so as to achieve the light diffusing effect.

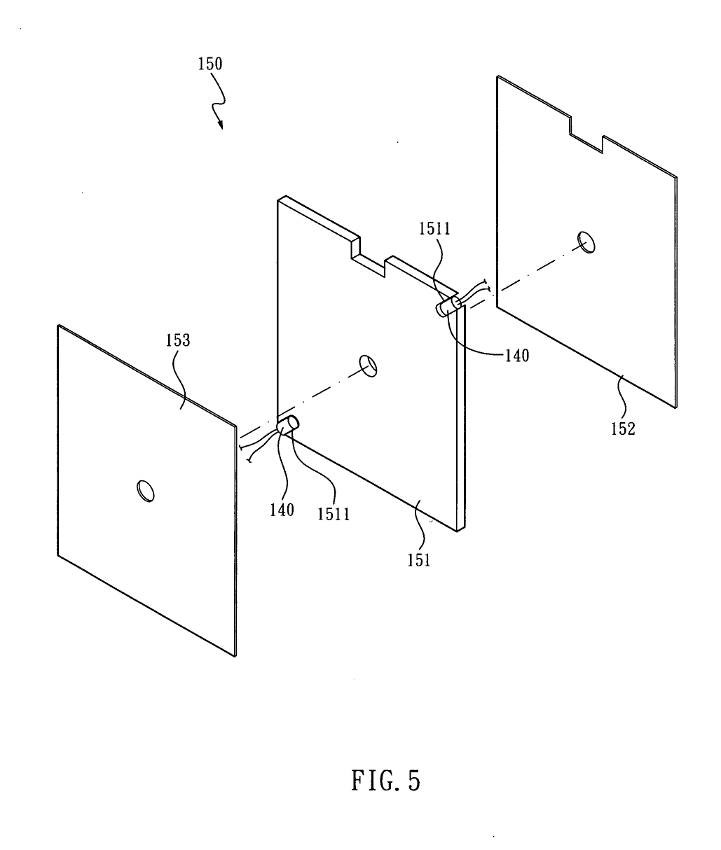

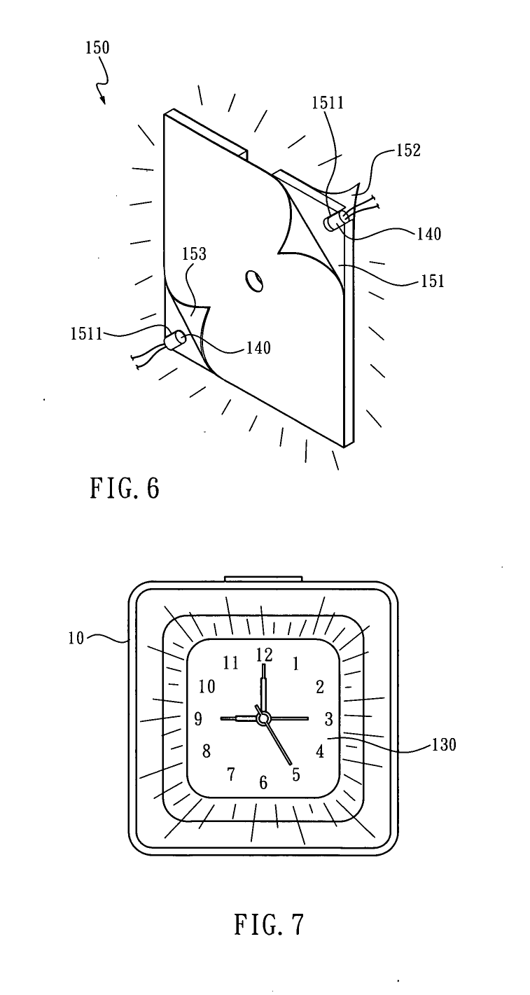

Referring to FIG. 5 and FIG. 6 which are an enlarged exploded view and an implementing view showing the light diffusion unit provided on the indicator timepiece of the present invention and the implementation thereof. The light diffusion unit (150) is set between the fastening member (160) and the time indicating unit (130) and contains at least one diffraction sheet (151), and further includes a reflection sheet (152) and a light softening sheet (153).

Therein, the reflection sheet (152), the diffraction sheet (151) and the light softening sheet (153) are aligned against the fastening member (160) and therefrom laminated on each other in sequence toward the time indicating unit (130) and set on another side of the fastening member. The diffraction sheet (151) contains two corresponding positioning slots (1511) at the diagonal corners to receive each lighting end of the two lighting devices (140), which are two LEDs in the present invention, mounted respectively at the positioning slots (1511) in the diffraction sheet (151). Thus when each of the LED (40) generates a light under the control of the circuit board (110), the light will be received by a thickness direction section of the diffraction sheet (151) so as to diffract and distribute the light into the whole diffraction sheet (151).

Above description is about the structural features of the present invention; the following context illustrates the optical principle applied to such structural features. Diffraction is a phenomenon occurred when a group of waves passes an obstacle and keeps spreading by means of scattering. In the present invention, when a light enters the thickness direction section of diffraction sheet (151), it scatters throughout the diffraction sheet so as to distribute the light all over the diffraction sheet (151). At that time, the reflection sheet (152) adjacent to the diffraction sheet (151) directs the light from the diffraction sheet (151) to the fastening member (160) into time indicating unit (130); in other words, reflecting the light back to the diffraction sheet (151) to enhance the availability of the light. Subsequently the light softening sheet (153) softens and conducts the light into the time indicating unit (130) so that the light presents on the time indicating unit (130) as soft and even, sheet-like lighting as shown in the FIG. 7.

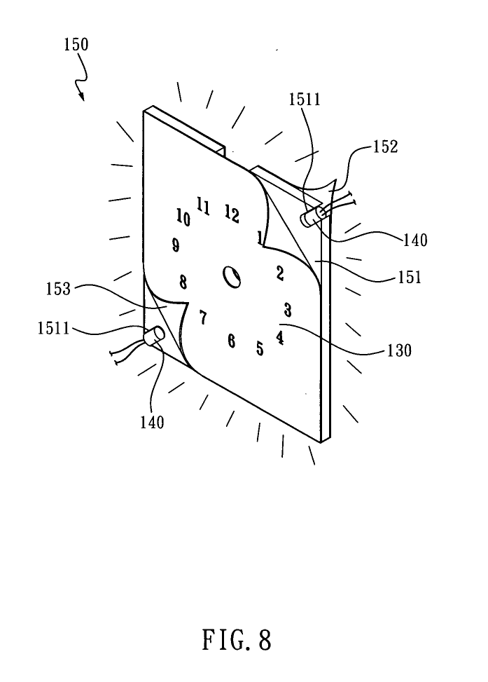

In the above embodiment, the time indicating unit (130) contains a sheet made of a transparent material and printed with time indicating figures and at least one hour hand and a minute hand connected with the timepiece movement. In the embodiment illustrated by FIG. 8, the time indicating unit (130) may be constituted by a light softening sheet printed with time indicating figures and a hour hand, a minute hand and a second hand connected to the timepiece movement (as shown in FIG. 7).

To sum up, the present invention discloses the light diffusion unit (150), equipped between the fastening member (160) and the time indicating unit (130), that diffuses and softens a dot light source such as a LED (140) by means of optical principle, and thereby turns a sector-like lighting zone into a sheet-like lighting zone without adding any LED or any electrical device. Prior to the assembling, the light diffusion unit (150) can be preassembled by lamination and integrated with existing manufacturing procedure of timepiece for mass production. Furthermore, the diffraction sheet (151) can be made of any transparent material such as cost-effective and lightweight acrylic plate while the reflection sheet (152) and light softening sheet (153) can be made of plastic film undergone surface treatment for causing necessary benefits on the condition that no considerable cost and weight will be incurred, and the light diffusing effect works effectively and reliably in existing timepiece.

Therefore, the indicator timepiece having a light diffusing effect described in the present invention is beneficial for telling the time at night or dark place and making it serve as a lighting device. The light diffusion unit is simple in structure and adaptive to existing assembling procedure of timepiece without any additional device and working process. Besides, the material used in light diffusion unit is cost-effective and durable, thus allowing the light diffusion unit at a lower cost and longer lifespan than the traditional lighting device.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention rather than limit the scope of the present invention. Accordingly, the foregoing description and drawings are by way of example only.

What is claimed is:

1. An indicator timepiece having a light diffusing effect, the indicator timepiece comprising:
a circuit board connected with and controlled by a power supply;
a timepiece movement electrically connected with and controlled by the circuit board to count time;
a time indicating unit connected with and controlled by the timepiece movement to display the time;
a lighting device electrically connected with and controlled by the circuit board to generate a light, and
a light diffusion unit set between the timepiece movement and the time indicating unit and enclosing the lighting device therein to provide at least diffraction to the light generated from the lighting device,
thereby converting the light into a sheet-like lighting on the time indicating unit.

2. The indicator timepiece having the light diffusing effect of claim 1, wherein the light diffusion unit is composed of a diffraction sheet made of a transparent material and at least one positioning slot is formed thereon for receiving the lighting device.

3. The indicator timepiece having the light diffusing effect of claim 2, wherein the light diffusion unit contains an opaque reflection sheet set between the timepiece movement and the diffraction sheet so as to reflect the light from the diffraction sheet toward the time indicating unit.

4. The indicator timepiece having the light diffusing effect of claim 2, wherein the light diffusion unit contains a light softening sheet that is made of a transparent material and set between the diffraction sheet and the time indicating unit so as to soften and conduct the light into the whole time indicating unit.

5. The indicator timepiece having the light diffusing effect of claim 1, wherein the time indicating unit includes a sheet made of a transparent material and printed with time indicating figures and at least one hour hand and a minute hand connected with the timepiece movement.

6. The indicator timepiece having the light diffusing effect of claim 4, wherein the time indicating unit includes the light softening sheet printed with time indicating figures and at least one hour hand and a minute hand connected with the timepiece movement.

7. The indicator timepiece having the light diffusing effect of claim 1, wherein the lighting device includes at least one LED.

8. The indicator timepiece having the light diffusing effect of claim 1, further comprising a fastening member for fixing the timepiece movement thereon and having the light diffusion unit set between the fastening member and the time indicating unit.

9. An indicator timepiece having a light diffusing effect, the indicator timepiece comprising:
a circuit board connected with and controlled by a power supply;
a timepiece movement electrically connected with and controlled by the circuit board to count time;
a time indicating unit connected with and controlled by the timepiece movement to display the time;
a lighting device electrically connected with and controlled by the circuit board to generate a light; and
a light diffusion unit including a diffraction sheet made of a transparent material and provided with a positioning slot for receiving the lighting device, an opaque reflection sheet set between the timepiece movement and the diffraction sheet for reflecting the light from the diffraction sheet toward the time indicating unit, and a light softening sheet made of a transparent material set between the diffraction sheet and the time indicating unit for softening and conducting the light from the diffraction sheet into the time indicating unit;
thereby converting the light into a sheet-like lighting on the time indicating unit.

10. The indicator timepiece having a light diffusing effect of claim 9 further comprising a fastening member for fixing the timepiece movement thereon and having the light diffusion unit set between the fastening member and the time indicating unit.
